(19) United States
(12) Patent Application Publication
(10) Pub. No.: US 2006/0149700 A1
(43) Pub. Date: Jul. 6, 2006

(54) System and method for automatic geospatial web network generation via metadata transformation

(76) Inventors: Randolph J. Gladish, Leesburg, VA (US); Alan P. Laviolette, Manassas Park, VA (US); Betty L. Davlin, Haymarket, VA (US); Ronald B. Natalie, Herndon, VA (US)

Correspondence Address: Pillsbury Winthrop Shaw Pittman LLP, 1650 Tysons Blvd., McLean, VA, 22102, US

(21) Appl. No.: 11/271,925

(22) Filed: Nov. 14, 2005

Related U.S. Application Data
(60) Provisional application No. 60/627,050, filed on Nov. 11, 2004.

(51) Int. Cl. G06F 17/30

(52) U.S. Cl. 707/1

(57) ABSTRACT

The invention provides a framework to create a network of omnidirectional web hyperlinks using data extracted from various geospatial data sources. The framework establishes a method of fusing disparate data sources, formats and locations into dynamic web documents that link interrelated data. Various linkage mechanisms are supported, including a method to control an application remotely from a web document.

The present invention claims the benefit of the filing date of U.S. Provisional Patent Appln. No. 60/627,050, filed Nov. 11, 2004, which is hereby incorporated by reference in its entirety, including appendices A, B and C filed therewith.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Field of the Invention

The present invention relates generally to geospatial and temporal data mining. More particularly, the present invention relates to an application framework that can be customized to expedite the analysis of image and vector features and create a collection of established associations between the features and conditions implied in the data content with existing stores of knowledge by creating a browsable document containing automatically generated interlink.

2. Background of the Invention

In conventional geospatial analysis and exploitation, it is necessary to reference multiple sources of information relating to a feature found in an image (overhead or aerial orientation typical), to a well-defined location, or to a separately identified feature of interest to determine a context for analysis. This has traditionally required manual data entry by the analyst and institutional knowledge of the numerous sources of related information. Manual data entry is time consuming and error prone.

Typically, each image includes various pieces of information associated with that image. This information is generally stored as metadata. For example, the image may include a specific geospatial location, date and time stamp, and a country code describing the image. If an analyst has access to this metadata, the analyst can search in one or more databases and retrieve information relevant to that image and link it to the image. In response to this manual linking and searching, recent advances have been made that provide a minimal amount of linkage between small numbers of data sources. However, the need to predetermine the interlinkage still exists and this has inhibited the creation of an effective mechanism for linking the data sources to the particular image or geospatial data under analysis.

Therefore, there is a need for a mechanism that makes it simple to create a central collection of links to data related to the geospatial data(s) under analysis. It is an object of the present invention to obviate or mitigate the above-mentioned disadvantages.

### BRIEF SUMMARY OF THE INVENTION

The invention provides a framework to create a network of omnidirectional web hyperlinks using data extracted from various geospatial data sources. The framework establishes a method of fusing disparate data sources, formats and locations into dynamic web documents that link interrelated data. Various linkage mechanisms are supported, including a method to control an application remotely from a web document. A multitude of metadata manipulation, reformatting, parsing and conversion mechanisms are present in the framework to support metadata fusion.

In one embodiment, the present invention is a method for associating data stored in disparate locations into a single document. The method includes extracting at least one piece of data that describes content of the document. The extracted at least one piece of data is transformed into search-compatible form. At least one data source is then searched using the transformed at least one piece of data. Information is retrieved from the at least one data source, and the retrieved information is transformed into a processing-compatible form. Then the retrieved information from the data source is associated with the document.

In another embodiment, the present invention is a system for associating data stored in disparate locations into a single document. The system includes a computer having an image display coupled thereto. An image is displayed to a user on the image display. The system also includes a template to be executed by the computer to process the image, wherein the template contains references to one or more local or remote databases to obtain, reformat and transform the additional information and cause it to be displayed as annotations on the image or vector layer. Embodiments of the present invention can further include a macro processor executing on the computer for processing macros in the template.

### BRIEF DESCRIPTION OF THE DRAWINGS

FIG. 1 is a flow chart for a method for associating data stored in disparate locations into a single document according to an embodiment of the present invention.

FIGS. 2A and 2B illustrate an exemplary template according to an embodiment of the present invention.

FIG. 3 is a schematic diagram of a system for associating data stored in disparate locations into a single document according to an embodiment of the present invention.

### DETAILED DESCRIPTION OF THE INVENTION

The present invention provides a method and a framework for associating data stored in disparate locations into a single document. This document may provide the contextual framework for all information that is deemed relevant by the document creator. For example, a real estate agent may want to have accessible the taxes paid for the last five years, any constructions that required building permits, easements assessed against the property, along with the MLS listing for a property identified in an aerial image, such as commercial satellite or aerial survey imagery. Additional information that may be helpful is the number and location of schools in the area, nearest grocery stores, or any other information that a potential purchaser could find helpful. Embodiments of the present invention provide for automatically extracting and transforming one or more metadata elements to be used as an index to one or more external database records and for assembling and reformatting the disparate information for display using various standard information display technologies, including spreadsheet applications, web browsers, and text browsers.

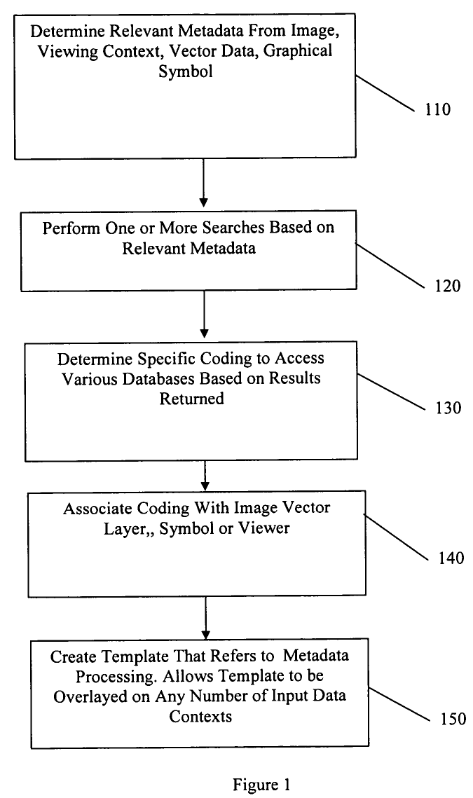

FIG. 1 is a flow chart for a method for associating data stored in disparate locations into a single document according to an embodiment of the present invention. In step 110, relevant information pertaining to a document is determined. Typically, the relevant information is provided in metadata associated with a document. For example, where the document is an electronic image, additional information describing the collection (metadata), such as geodetic location, acquisition time, collector (or camera) settings are stored along with the electronic image. Thus, in step 110, the geodetic location time of acquisition, camera orientation and other parameters associated with the electronic image can be obtained. In the real estate example above, for example, the geodetic location of a building in the image can be obtained. The acquisition (collection) date of the image may be obtained as well to be used when a temporal reference is needed for information that changes over time. Each data retrieval system has specific and often inflexible input formatting requirements for the key retrieval parameters. These formatting requirements are often in incompatible with the metadata present in the original document. Embodiments of the present invention provide the necessary transformation mechanisms to transform the retrieval parameters as required.

Using the obtained information, in step 120 one or more queries are performed against various databases to collect additional information related to the obtained metadata. Each data retrieval system (database, web service or otherwise) has a specific and often inflexible output form in which results are returned. Some retrieval systems support well known protocols, such as XML and ODBC. Other systems produce results that require manipulation into a displayable form. In either case, embodiments of the present invention provide the necessary transformation mechanisms to manipulate the retrieved information. For example, in the real estate example, various databases may be searched to find the taxes paid for the last five years, any construction on the property that required building permits, easements assessed against the property, the MLS listing for the house, the number and location of schools in the area, nearest grocery stores, and any other desired information regarding the dwelling.

In addition to the specific information provided, each of the searches returns a specific string of data or coding for accessing that information. These codings are captured in step 130.

In step 140, the additional information collected about the image is loaded into a file along with the document and displayed to a user of the system. In the context of the real estate embodiment, for example, the dwelling can be shown in an image along with annotations displaying the additional collected information. In step 150, the specific requests are converted into more generalized requests in the form of a template that can be applied against other documents.

Templates are computer files that contain generalized instructions for associating data stored in disparate locations into a single document. A template comprises a series of statements, called macros, that perform the required functions to extract desired data to show to the user.

A macro is a small series of program code steps that can be implemented by itself or invoked by command of another program or macro. Each macro causes a particular function or functions to be performed. In embodiments of the present invention, macros are typically created to access metadata from an image or to query databases. The template, then, comprises one or more macros that, when executed, associate data stored in disparate locations into a single document.

Templates in embodiments of the present invention can further include variables. Within the template, variable information is typically delimited, for example, by using $ signs. Typically this variable information retrieved from the metadata of a document, such as an electronic image. Once the template is created, it can be applied generally to any document. For example, a template created to process mapping imagery can be applied to any map image. Further, as described above, once the administrator knows how to access information from a specific database, a macro can be created that will allow it to access the same information for different geographical locations.

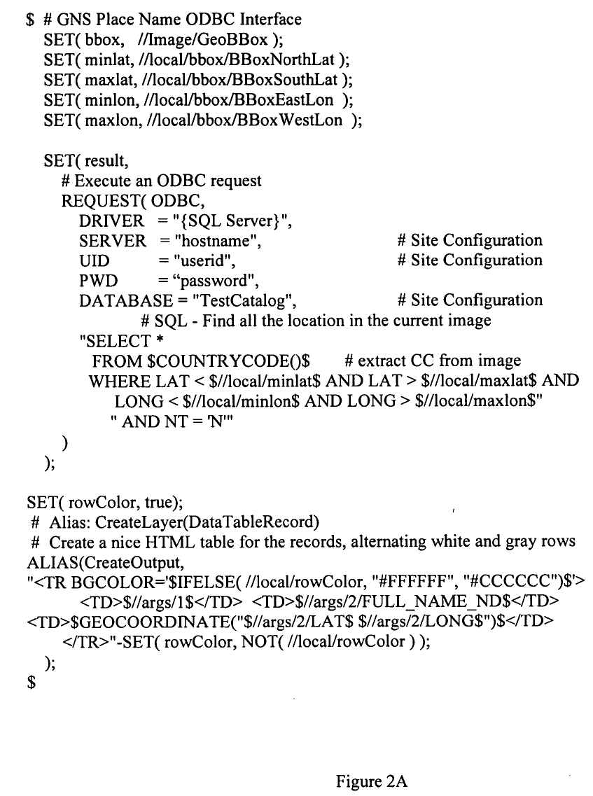

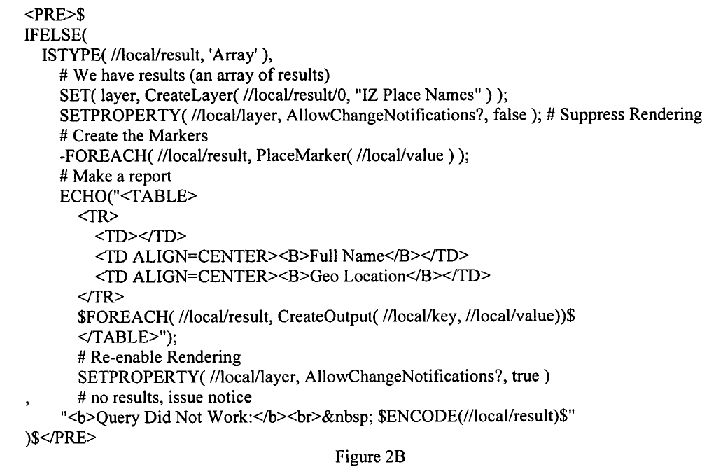

An exemplary template for a mapping application is provided in FIGS. 2A and 2B. The exemplary template in FIGS. 2A and 2B is used to extract place names from a database and place use the extracted place names to annotate an electronic map of an area. The appendix attached hereto, and incorporated herein by reference, contains additional exemplary templates at pages 25-27, as well as a description of macros and text substitution for an embodiment of the present invention known as Remote View offered by Sensor Systems.

The template shown in FIG. 2A begins with a series of “SET” macros. As described in Appendix A, the “SET” macro established value for local variables. The particular “SET” macros establish variables to store the geographical boundary of a particular image map in local variables “bbox”, “minlat”, “maxlat”, “minion” and “maxlon”. The geographical boundary is logically stored as a geographical boundary box defined by the foregoing variables.

The template then sets up a database query in the variable “result”. The variable “result” is used to query a database to obtain place names corresponding to locations with the geographical boundary defined the geographical boundary box. The template continues by creating an alias, “CreateOutput”. As described in Appendix A, an alias is a user-defined macro. The user-defined macro “CreateOutput” generates an HTML table structure into which all place names extracted from a particular database will be stored along with their corresponding latitudes and longitudes. In FIG. 2B, the template annotates the image map with the extracted place names and returns a coded string from the search. The template in FIG. 2B will, for each of the returned results in the array, create a row in an HTML table and create a labeled marker in the image overlay

Once the template document is created with all the desired information, the template may be automatically applied to any number of images or vector data sets.

Site Administrator

A site administrator is the person or persons designated to configure site-specific content templates. The exemplary embodiment of the present invention also permits individual users to designate template in a similar manner. The role of the site administrator is to determine what types of information an end user by encapsulating the analysis resources available and to capture the understanding the significance of an image. This can vary from military images where it is important to overlay known reference points over an image or the nature of the location (i.e., its significance to military operations) to commercial images such as those described above for property boundary litigation or real estate agents.

End User

From an end user's perspective, for a given location, a plurality of information is obtained that is relevant to, or keyed to, the geospatial location in the image, or the viewing context established by viewing a portion of an image, vector data layer, map or other geospatially, temporally attributed data source. For example, if a satellite image containing a residential property such as a single family dwelling is displayed, the assembled information may contain the current taxes assessed against the property, the MLS listing for the house, and any easements or other geospatially referenced information recorded against the property. This information may all be provided in one or more web pages with links to the specific information associated with the image or viewing context. The end user need not know where or how the information was obtained, thus providing an inexperienced operator with the data mining results of a more experienced operator. What is important to the end user is that the information associated with the information is relevant to the particular needs of the user.

The end user may customize the web page further to include additional text, video, or other information that the user believes is relevant to the image. The end user may publish the document, with or without further customization, so others may access the information associated with the image. For example, the end user may want to provide video footage about the residential location and associate it with the web page so that others may also access the information. Finally, by publishing the document, the end user may create a historical record of the location associated with the image to see changes over time. For example, in the example of the residential location, a deck or other building structure may be added to the dwelling and the end user may want to track the progress of the construction. The end user may want to further modify the particular image to include information such as a copy of the building permit.

The present invention may be utilized on any computer platform. Any web-enabled device like personal computers, hand-held computers, PDAs, and cell-phones with sufficient network bandwidth can interact with the present invention. An exemplary embodiment of the present invention is shown in FIG. 2. As shown, the end user or site administrator can view images on the image display and perform the other related functions as described above.

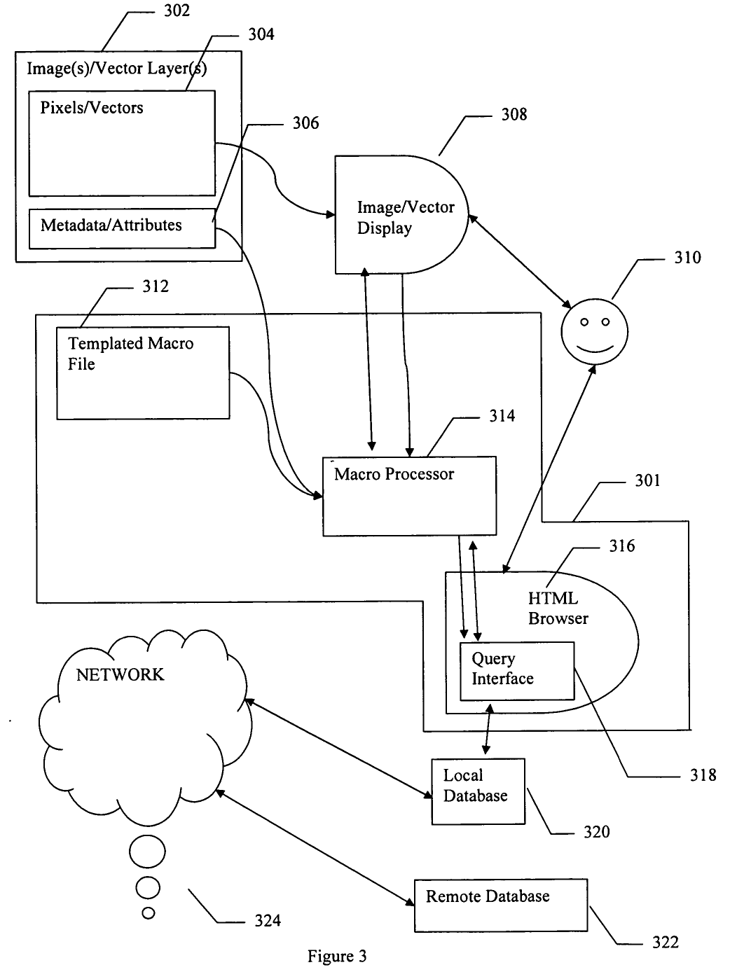

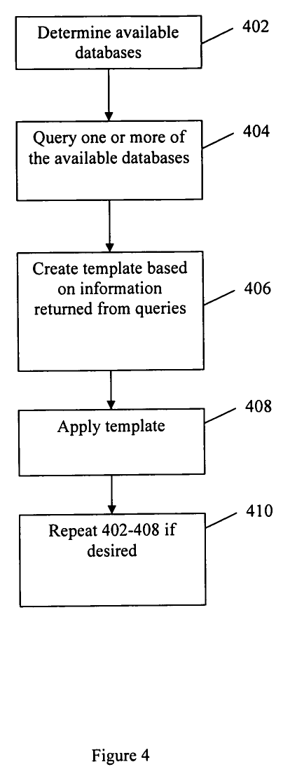

FIG. 3 is a schematic diagram of a system for associating data stored in disparate locations into a single document according to an embodiment of the present invention. Portions of embodiments of the present invention are executed on a computer 301. Computers that can be configured to execute embodiments of the present invention as described herein are well-known and need not be described further. A user 302 views an image or vector data layer 304. The system is described with respect to a document that is an image or vector data layer. However, embodiments of the present invention are applicable to documents generally that have metadata associated with them that can be used to acquire data from sources outside the document to enrich the information provided by the document.

The data corresponding to the image comprises pixel data 308, that is the image itself. In addition, the data corresponding to the image comprises metadata 308 that describes the image. The data may also consist of a layer of vector data containing attributes unique to each vector object in the layer. For example, the metadata may include geolocation data, date and time information, source information and other data associate with an image. The vector layer attributes may contain information such as zip code, feature description codes and other data associated with each particular vector object. These metadata and attribute information are used to associate external information with content in the image and/or vector layer.

The image pixel data and/or vector data is displayed on a display 308. Through the embodiment of the invention, metadata/attribute information is extracted from the image/vector data and is used to query one ore more databases through a query interface 318. Macros from a macro processor 314 can be used to facilitate extracting the metadata. Query interface 318 can query one or more local databases 320 or remote databases 322 through a network 324. Network 324 can be any computer network including a wide area network (WAN), local area network (LAN), intranet, internet, including the Internet or any other computer network.

Coding information in the form of query results strings are returned as a result of the search. The template macro file can be applied to any image, vector data, or viewable context within any application utilizing the invention to process the results, including, but not limited to, generation of annotations for the image and external report documents. For example, a user 302 desires to add place names to an image. The user applies a template such as that shown in FIGS. 2A and 2B. Upon application of the template, macros in the template perform various functions, such as querying one or more local database 320 and/or one or more remote databases 322 with metadata extracted from the image. The queried databases return information responsive to the queries to the macro processor for display as annotations in the image on image display 308. For example, the additional information can be added to the image through HTML browser 316.

Embodiments of the present invention can also be web server based. In a web server based embodiment of the present invention, a user enters a universal resource locator (URL) into a web browser. The URL points to a script to run. The execution of scripts from application servers are well-known art and need not be described further. The script may optionally prompts the user for addition execution parameters, thereby allowing the user to select the information they want to see. For example, the user may be prompted for the information using a graphical user interface. The script causes one or more local and/or remote databases to be found, queried, and returns the results as described above for display to the user or additional processing and metadata transformation. In web server embodiments of the present invention, local and remote databases are queried to determine what information they contain. That information is automatically processed, or presented to the user to select the particular information desired for processing/display.

Web server embodiments of the present invention allow multi-step processes such as wizards to be run. For example, a wizard could lead the user through the selection process to generate the desired end product report.

FIG. 4 is a flow chart of a method for associating data stored in disparate locations into a single document according to a web server embodiment of the present invention. The method is executed in a script that is invoked when the user enters a URL pointing to the script. In step 402, a list of available databases is determined. For example, using well known ODBC, a list of databases housed in a particular computer can be discovered. Using such lists for one or more of the computers on a network provides a list of available databases. Alternatively, the available database or databases can be preconfigured (hard coded) into the script. The available databases can be either local databases or remote databases. In step 404, one or more of the available databases is queried to determine the information it contains. For example, well known Structured Query Language (SQL) statements can be used to analyze fields in database tables. One or more of the available fields is returned to the user, who selects which fields the user desires. For example, the user may be interested in latitude, longitude, date and time. Further, the user can provide additional information about the desired data. For example, the user can indicate a desire to have all of the information about an image returned, or only information within an area bounded by a 10 arc minute by 5 arc minute region, centered about a specified latitude and longitude, or have information returned within an area graphically selected by the user, and/or information relating to a certain time period returned.

In step 406, a template is created. The template is similar to the templates described above, except that no site administrator is required to set up the template, and the template is not hard coded initially. After the template is created, in step 408 the template can be applied to images as described above. In step 408, the template is applied as described above. In step 410, if desired repeat steps 402-408, for example, to obtain information from a different database.

In addition to storing templates, the user can choose to save all of the queries performed through the various database as a stored configuration. The next time the user desires to perform the same steps on a database, the user only has to recall and execute the stored configuration.

Embodiments of the present invention can also be operated in a batch mode. In batch mode, a standalone computer is provided to execute the template scripting language described above, and in the Appendix. Embodiments of the batch mode do not require a graphical user interface. Rather scripts are run against the image data files to produce a report, processed imagery, processed web pages, and/or processed data. Thus, a batch embodiment of the present invention allows script to be run against many images files without repeating steps for each dataset.

The script can also be used to generate an RSS feed. RSS is a well known XML file format that describes changes that occur in a file. In embodiments, the RSS feed can be used to generate one or more hyperlinks that show the results of the processing over time.

Embodiments of the present invention also provides the ability to dynamically change the interface with which a user interacts. This feature provides a customizable user interface for embodiments of the preset invention. Embodiments of the present invention provide a “right-click” menu. That is, by right clicking the mouse or mouse equivalent (e.g., a keyboard mouse), options are provided to the user. For example, the user may be able to “Google” the name of a particular building in a drawing, transfer to a mapping website such as Mapquest, switch to a different database for searching, query a database based on information under the mouse pointer, bring up other applications, or perform any of a number of operations. Embodiments of the present invention allow a user to expand the manufacturer-offered right-click options. This is done by changing the script accessed by the right-click option to perform whatever task the user desires.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in he art would appreciate, other sequences of steps may be possible.

What is claimed is:

1. A method for associating data stored in disparate locations into a single document, comprising:
extracting at least one piece of data that describes content of the document;
transforming the extracted at least one piece of data into search-compatible form;
searching at least one data source using the transformed at least one piece of data;
retrieving information from the at least one data source;
transforming the received information into a processing-compatible form; and
associating the information from the data source with the document.

2. The method according to claim 1, wherein searching at least one data source comprises searching multiple data sources and information retrieve from each of the data sources is associated with the image.

3. The method recited in claim 1, wherein the at least one data source is a database or web accessible data retrieval service.

4. The method recited in claim 1, wherein the at least one piece of data is metadata, further comprising retrieving information from the data source using the metadata.

5. The method recited in claim 1, further comprising:
creating a template; and
applying the template to metadata-rich document or context with appropriate formatting and data transformation.

6. The method recited in claim 1, wherein the document is an image document, further comprising:
Collecting metadata information, such as latitude, longitude, elevation, and acquisition date and time information from the image document, and applying/transformation as appropriate to associate aforementioned information with to at least one data source to retrieve additional information corresponding to the document or viewing context; and
displaying the retrieved additional information to a user as annotations to the image.

7. A system for associating data stored in disparate locations into a single document, comprising:
a computer;
an image display coupled to the computer for displaying an image to a user; and
a template to be executed by the computer to process the image, wherein the template contains references to one or more local or remote databases to obtain, reformat and transform the additional information and cause it to be displayed as annotations on the image or vector layer.

8. The system recited in claim 7, further comprising a macro processor executing on the computer for processing macros in the template;

9. The system recited in claim 7, wherein the template contains references to one or more local and remote databases.

10. The system recited in claim 7, further comprising a web application server, in conjunction with a web browser over a network to extract, generate, control and display image, vector, metadata and external information in association with data or other geospatial, temporal context.

11. The system recited in claim 9, wherein the template further identifies available databases and provides a list of available fields to the user for selection of fields of interest.

12. The system recited in claim 7, further comprising a computer network through which at least one remote database is accessed.

13. The system recited in claim 7, further comprising a customizable right-click menu.
